(19) United States
(12) Patent Application Publication
(10) Pub. No.: US 2011/0019081 A1
(43) Pub. Date: Jan. 27, 2011

(54) DEVICE FOR COUPLING A CAMERA AND LENS ASSEMBLY TO A BELT

(76) Inventor: Shai Eynav, Ithaca, NY, NY (US)

Correspondence Address: CHRISTINE JOHNSON ESQ., 151 Trenton Rd., Fairless Hills, PA, 19030, US

(21) Appl. No.: 12/678,741

(22) PCT Filed: Sep. 18, 2008
(86) PCT No.: PCT/US08/76878

§ 371 Date: Oct. 17, 2010

Related U.S. Application Data
(60) Provisional application No. 60/973,424, filed on Sep. 18, 2007.

(51) Int. Cl. H04N 5/225

(52) U.S. Cl. 348/376; 348/E05.024

(57) ABSTRACT

Embodiments of the invention provide a device for coupling a camera to an article of clothing, for example, a belt, of a wearer. The coupling device comprises a slot engaging portion on one end for engaging a slotted receptacle of a support structure. The device includes a camera engaging portion on another end for engaging a thread receiving receptacle of a camera. The coupling piece is configured to permit rotation of the camera with respect to the support structure when the thread receiving receptacle of the camera is engaged with the camera engaging portion, and when the slot engaging portion is engaged with the slotted receptacle.

### CROSS REFERENCE TO RELATED APPLICATIONS

The present application claims priority to U.S. provisional application Ser. No. 60/973,424, filed Sep. 18, 2007 by the same inventor and incorporated herein by reference.

### FIELD OF THE INVENTION

The present invention relates to device for coupling a camera to a belt of a wearer and more particularly to a device that couples a camera and an optional lens assembly securely to a wearer's belt while permitting the wearer to quickly and easily uncouple the camera and lens assembly from the belt, the coupling device further designed to accommodate movement of the wearer.

### SUMMARY OF THE INVENTION

Embodiments of the invention provide a coupling for coupling a camera to an article of clothing, for example, a belt, of a wearer. The coupling devices comprises a slot engaging portion on one end for engaging a slotted receptacle of a support structure. The device includes a camera engaging portion on another end for engaging a thread receiving receptacle of a camera. The coupling piece is configured to permit rotation of the camera with respect to the support structure when the thread receiving receptacle of the camera is engaged with the camera engaging portion, and when the slot engaging portion is engaged with the slotted receptacle.

### DESCRIPTION OF THE DRAWING FIGURES

These and other objects, features and advantages of the invention will be apparent from a consideration of the following detailed description of the invention considered in conjunction with the drawing figures, in which:

FIG. 1 is an illustration of a camera detachably coupled to a wearer's belt using a coupling device according to an embodiment of the invention.

FIG. 2 is an illustration of a camera coupled to a wearer's belt as illustrated in FIG. 1 by a coupling device according to an embodiment of the invention wherein the camera is shown as it appears when swiveled about an axis of the coupling device with respect to the belt.

FIG. 3 is a top view of a coupling device according to an embodiment of the invention securing a camera and lens assembly to a wearer's belt wherein the camera and lens assembly is swiveled about an axis of the coupling device to accommodate a seated position of the wearer.

FIG. 4 is a top view of a coupling device according to an alternative embodiment of the invention securing a camera and lens assembly to a wearer's belt wherein the camera and lens assembly is swiveled about an axis of the coupling device to accommodate a seated position of the wearer.

FIG. 5 illustrates a second part of a coupling device according to an embodiment of the invention.

FIG. 6 is a perspective view of a first part of a coupling device configured in accordance with an embodiment of the invention.

FIG. 7 is a perspective view of a coupling device according to an embodiment of the invention illustrating a first part and a second part positioned for sliding engagement.

FIG. 8 is a top view of a first part attached to a camera according to an embodiment of the invention.

FIG. 9 is a front view of a second part of a coupling device configured in accordance with an embodiment of the invention.

FIG. 10 is a perspective view of a coupling device according to an embodiment of the invention illustrating a first part and a second part positioned for sliding engagement.

FIG. 11 is a front elevation view of a first part of a coupling device according to an embodiment of the invention.

FIG. 12 is a top view of the first part of the coupling device illustrated in FIG. 11 as seen when the first part is attached to a camera.

FIG. 13 is a rear elevation of a first part of a coupling device according to an embodiment of the invention.

FIG. 14 is a perspective view of a camera protecting part of a coupling device according to an embodiment of the invention.

FIG. 15 is a perspective view of a coupling device showing the first and second parts coupled together and in position for attachment of the camera protecting piece illustrated in FIG. 14.

FIG. 16 is a top view of the coupling device illustrated in FIG. 15 including the camera protection piece illustrated in FIG. 14.

FIG. 17 is a top view of a coupling device according to an alternative embodiment of the invention.

FIG. 18 illustrates an alternative embodiment of the invention.

FIG. 19 illustrates a coupling pin according to an embodiment of the invention

FIG. 20 is a top view of a clip according to an embodiment of the invention.

FIG. 21 is a front elevation view of a clip according to an embodiment of the invention.

FIG. 22 is a front view of a clip according to an alternative embodiment of the invention.

FIG. 23 is a perspective view of a clip according to an embodiment of the invention.

### DETAILED DESCRIPTION OF THE INVENTION

In accordance with the present invention, there is provided herein an apparatus for fastening a camera and lens assembly to a belt of a wearer. A coupling device according to embodiments of the invention permits a camera and lens assembly to be fastened securely to a wearer's belt while permitting a wearer to quickly and easily detach the camera and lens assembly from the belt. The fastening apparatus of the invention advantageously permits rotational motion of a camera and lens assembly relative to the belt to accommodate bending and seating positions of the belt wearer.

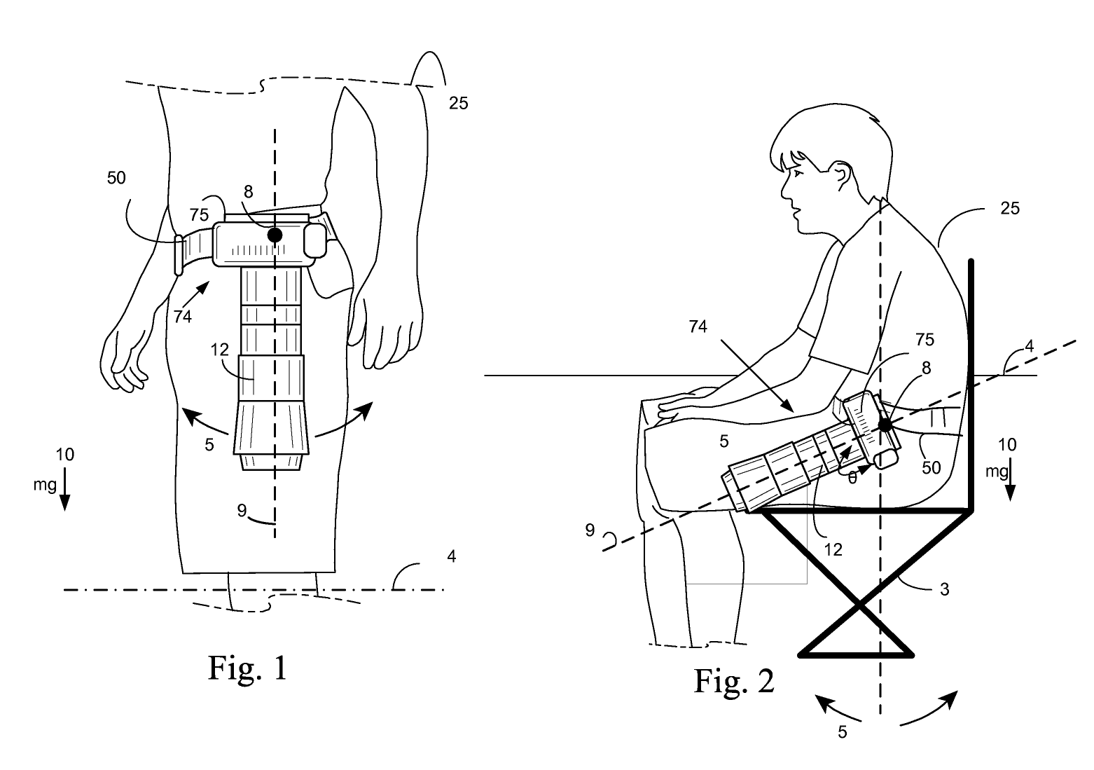

### FIGS. 1 and 2

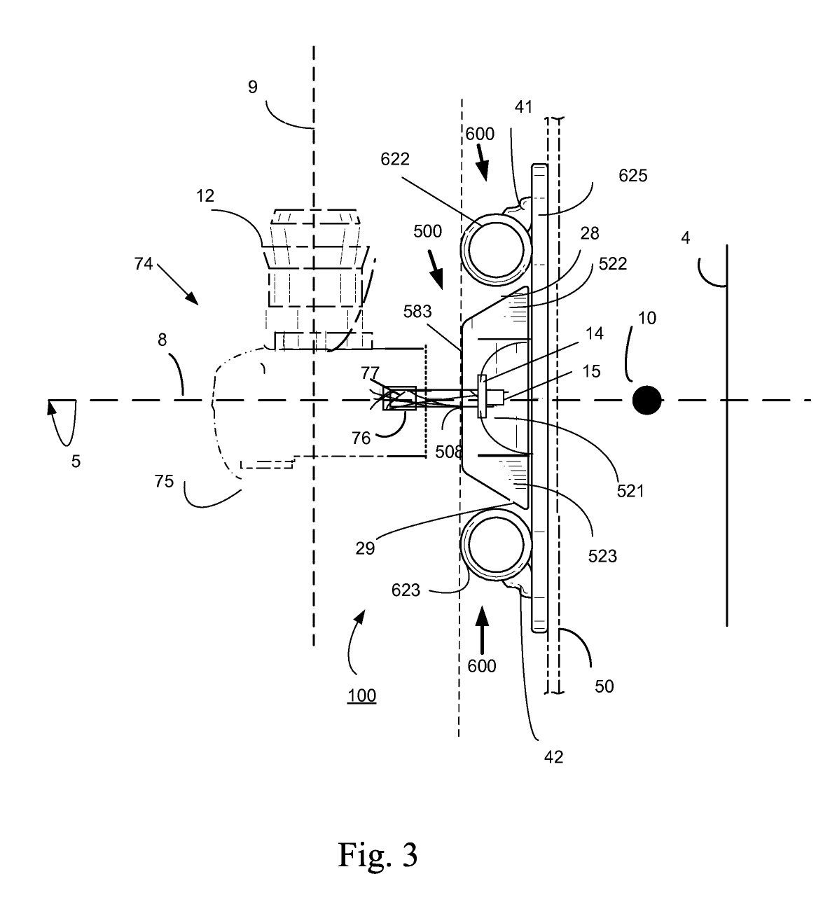

FIGS. 1 and 2 illustrate a camera and lens assembly 74 comprising a camera 75 and a lens 12 secured to a belt of a wearer by a coupling device (shown in FIGS. 3-19) according to an embodiment of the invention. Camera 75 comprises any of a wide variety of commercially available and custom made cameras. Professional as well as amateur cameras are suitable for use with the various embodiments of the present invention. It is important to note the invention is not limited in application to any particular type of camera 74. Further, the invention is useful in attaching camera 75 to belt 50 even when camera 75 is not equipped with a detachable lens 12 in a camera and lens assembly.

Photographers typically carry an assortment of portable lenses from which a particular lens 12 may be selected for attachment to a camera 75. A portable lens is typically attached to camera 75 by threaded engagement with a lens receiving portion of camera 75. When a photographer desires a different lens the photographer may detach one lens and attach a different lens. A lens 12 as illustrated in FIG. 1 is characterized by a lens housing of a generally tubular shape. However, the invention is not limited in application to any particular lens shape. The invention will find use in coupling a wide variety of cameras and camera lens assemblies to a belt 50.

FIGS. 1 and 2 illustrate a lens 12 extending from a camera 75 along a lens longitudinal axis 9. When belt wearer 25 assumes a standing posture, a coupling device (illustrated in FIGS. 3-16) according to embodiments of the invention permits assembly 74, including lens 12 to hang from belt 50 in response to gravitational force (direction indicated at 10) acting on the assembly perpendicular to the earth's surface (indicated at 4). In that posture lens longitudinal axis 9 extends parallel to a gravitational line of force 10. A coupling device of the invention permits assembly 74 to rotate about an axis 8 (axis 8 is indicated by a black dot and extends perpendicular to the plane of the drawing sheet) in response to forces other than gravity when these are exerted on the camera and lens assembly 74. For example, a coupling device of the invention permits assembly 74 to pivot about axis 8 for bidirectional movement of assembly 74 along an arc 5 responsive to force exerted by the wearer pushing the camera and lens assembly in either direction.

In that manner, coupling devices according to embodiments of the invention accommodate a variety of postures and positions of wearer 25 during a photo shoot. For example, FIG. 2 illustrates a camera and lens assembly 74 fastened to a belt 50 of a photographer 25 seated on a bench 3. An inventive coupling device permits assembly 74 to swivel about axis 8 along arc 5 to allow the photographer to sit on bench 3 without interference that would be encountered if camera and lens assembly 74 were not capable of rotation along arc 5. Without rotation, a photographer 25 would need to detach the lens 12 from camera 75 to sit on bench 3.

As illustrated in FIG. 2 assembly 74 is shown in a rotated position with respect to line of gravitational force 10. Thus wearer 25 can move from a standing position (illustrated in FIG. 1) to a sitting position (illustrated in FIG. 2) without the need to decouple lens 12 from camera 75 and without decoupling the assembly 74 from belt 50. When wearer 25 resumes a standing position, the coupling device permits assembly 74 to swivel downward (in direction 10) in response to the force of gravity acting perpendicular to the ground 4.

### FIG. 3 Coupling Device: First Embodiment of First Coupling Part

FIG. 3 is a top view of a coupling device 100 according to one embodiment of the invention. Coupling device 100 comprises a first coupling part 500 and an opposing second coupling part 600. First coupling part 500 is shown attached to a camera and lens assembly 74 by means of a pin 44. The distal end 77 of pin 44 is threaded for engaging a receptacle 76 of camera 75. The proximal end of pin 44 is disposed through an opening 508 of first coupling part 500 for pivotal engagement with an inside surface of opening 508. In that manner camera and lens assembly 74 is pivotable about a central longitudinal axis 8 of pin 44.

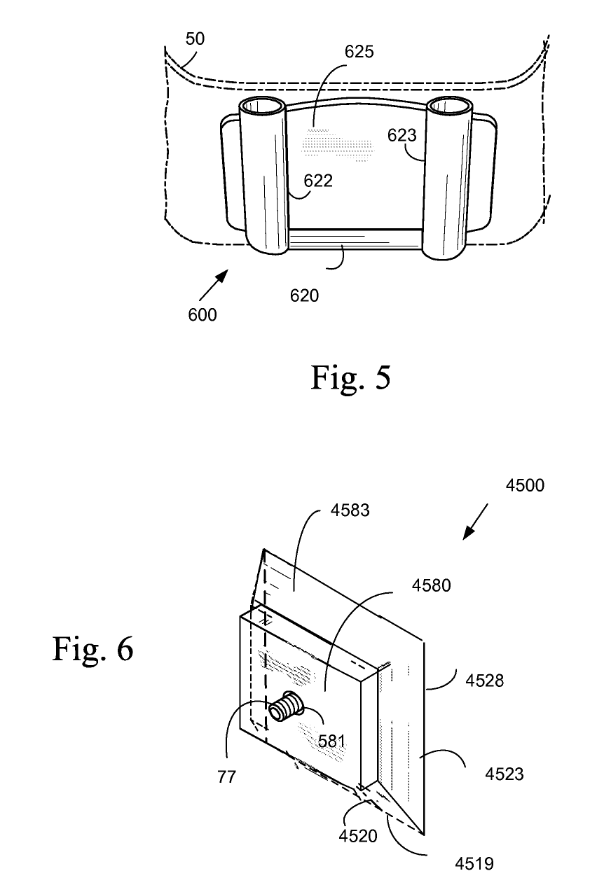

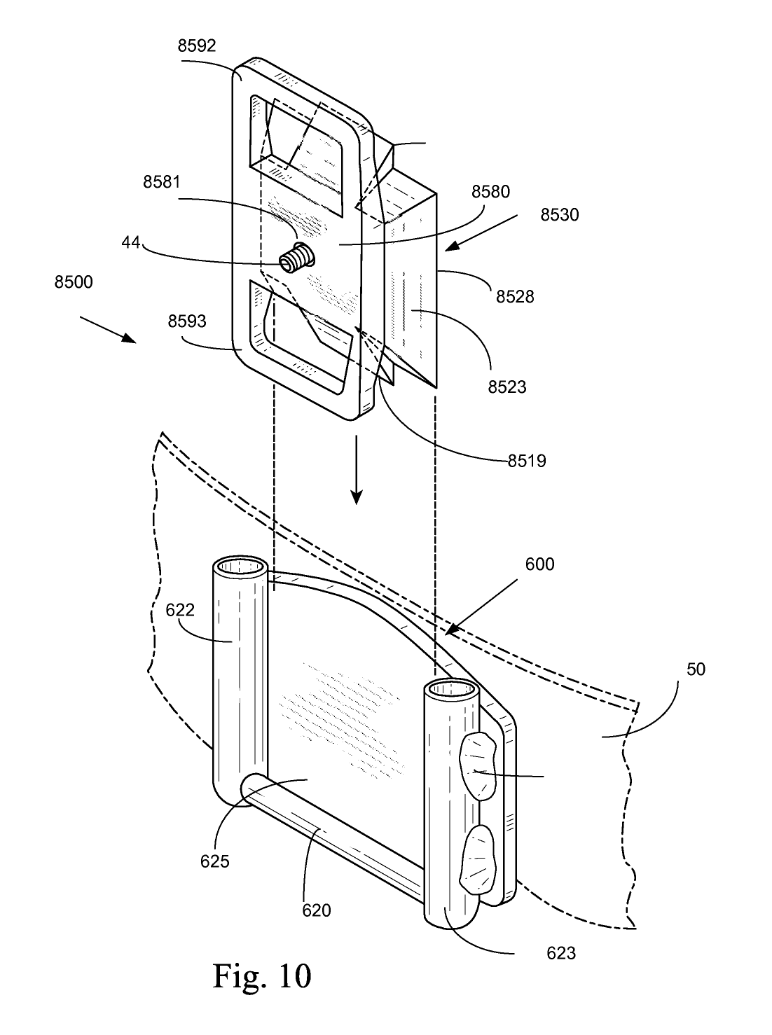

Second coupling part 600 is fixed to a belt 50. FIG. 5 is a perspective view of second part 600 according to an embodiment of the invention. Second part 600 comprises a base plate 625 having two guide members, 622 and 623 mounted thereupon. In one embodiment of the invention guide members 622 and 623 are fixed to base plate 625 by welding the guide members to the base plate. A weld suitable for mounting guides 622 and 623 to base plate 625 is illustrated in FIG. 10 at 43. Base plate 600 further comprises a slide stop flange 620 extending perpendicular to and outwardly from a plane of base plate 625. Slide stop flange 620 is disposed between guide members 622 and 623 at least partially between the lower portions of guide members 622 and 623. Slide stop flange 620 limits downward travel of a slide, for example, first part 500. Together, guide members 622 and 623 and slide stop flange 620 provide a slot for receiving first part 500.

In the embodiment of the invention illustrated in FIG. 5 guide members 623 and 624 are generally cylindrical in shape. In one embodiment of the invention guides 623 and 624 comprise hollow metallic cylinders. However the embodiment is not limited to cylindrical shapes. The invention is directed to guides 623 and 624 as configured to form slots to engage wedge portions of first part 500.

In one embodiment of the invention guides 622 and 623 are affixed to slide base plate 625 by welding. However, the invention is not limited to a particular means of affixing guides 623 and 624 to slide base plate 625. In one embodiment of the invention base plate 625 is fixed to belt 50 by, screws extending from inner surfaces of hollow guides 622 and 623, through base plate 625 and into the material of belt 50.

Returning now to FIG. 3 it is seen that first part 500 and opposing second part 600 couple camera and lens assembly 74 to a belt 50. Thus embodiments of the invention enable a wearer of belt 50 to adjust the position of camera and lens assembly 74 to accommodate bending and sitting of the wearer without obstruction or interference from the lens 12 of camera and lens assembly 74.

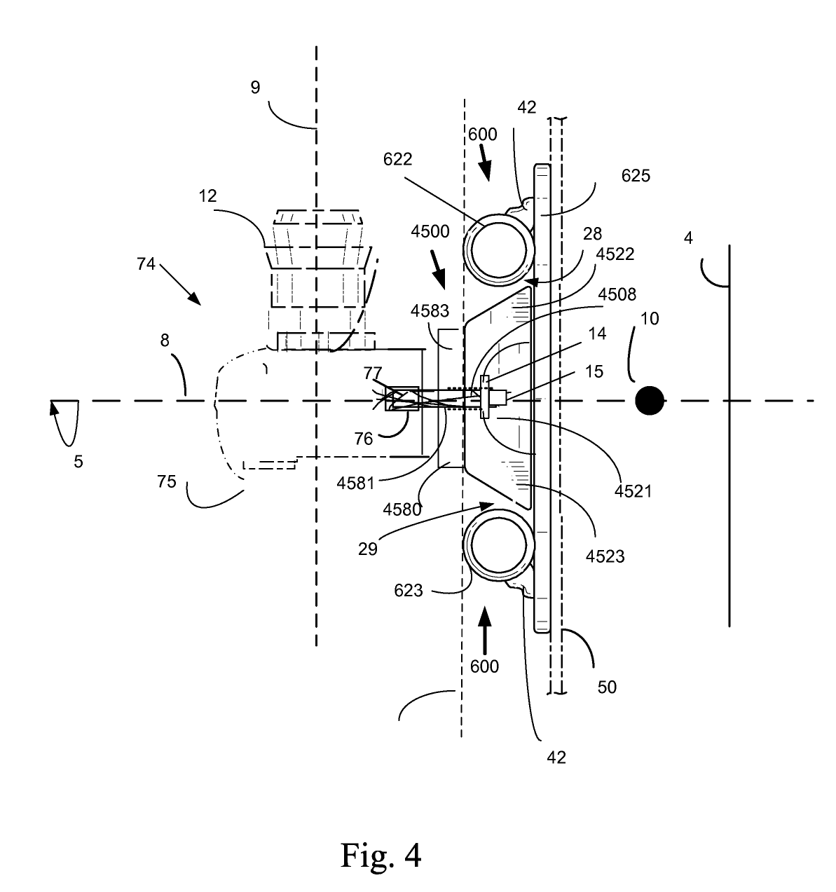

### FIGS. 4 and 6 Second Embodiment of First Coupling Device

FIG. 4 illustrates a first part 4500 of coupling device 400 according to an alternative embodiment of the invention. In the embodiment of FIG. 4, first part 4500 further comprises a slider base 4580. Slider base 4580 includes a central region defining an opening 4581 through slider base 4580. A central axis of opening 4581 is aligned with a central axis of opening 4509. FIG. 4 illustrates threaded pin 44 having an intermediate portion extending through openings 4581 and 4509. The distal end 77 of threaded pin 44 engages threads of receptacle of a camera 75. The proximal end 15 of threaded pin 44 extends through opening 4509 of second part 4500 and extends into a cavity 4521 formed on one side of first part 4500. A pin securing means, for example a nut 45 engages threads of the proximal end of threaded pin 44 so as to maintain at least a portion of proximal end 15 of threaded pin 44 within cavity 521 when coupling device 100 is assembled and in use.

Coupling device 400 further comprises a second part 600. Second part 600 is illustrated as attached to belt 50. First part 4500 is illustrated as affixed to a camera 1175. Together, second part 600 and first part 4500 secure camera 1175 to belt 1150.

FIG. 6 is a perspective view of the first coupling part 4500 illustrated in FIG. 4. A slider portion 4583 is rigidly fixed to a slider base 4580. Slider portion 4583 includes at least two laterally extending wedge portions 4522 (not visible) and 4523 extending outwardly from at least two opposite sides of a slider base portion 4580 at an angle with respect to a central longitudinal axis of pin 44. Wedge portions 4522 and 4523 form guide engaging edges 4527 (not visible) and 4528 respectively. A third wedge portion 4520 includes an edge 4519 that engages slide stop flange 620 (illustrated, e.g., in FIG. 5) to limit the sliding motion of first part 4500 with respect to second part 600 when the first and second parts are coupled together.

In the embodiment illustrated in FIG. 6 first part 4500 is generally rectangular in shape. However, the invention is not limited to rectangular shapes. Instead, a variety of shapes are suitable for forming first part 4500 and its components. For example round, oval, square, hexagonal and many other shapes are suitable for base 4580. Regardless of shape, slider base 4580 includes an opening 581 extending through a central portion of base 581.

In one embodiment of the invention the central opening 581 is of sufficient diameter to pass there-through the threaded end portion 77 of a threaded pin. The opening 581 is small enough to prevent passing there-through a head portion (not shown in FIG. 6 at the other end of the threaded pin. In that manner the threaded pin is coupled to the first part 4500 (i.e., first body portion 4500) when the first body portion is engaged with the slotted receptacle defined by base plate 625, guide members 622 and 623 and slide stop 620 of support structure 600 (illustrated in FIG. 5).

A second body portion has an opening there-through for passing the threaded end of the threaded pin such that the second body portion is coupled to the first body portion when the threaded end is engaged with the thread receiving receptacle of the camera.

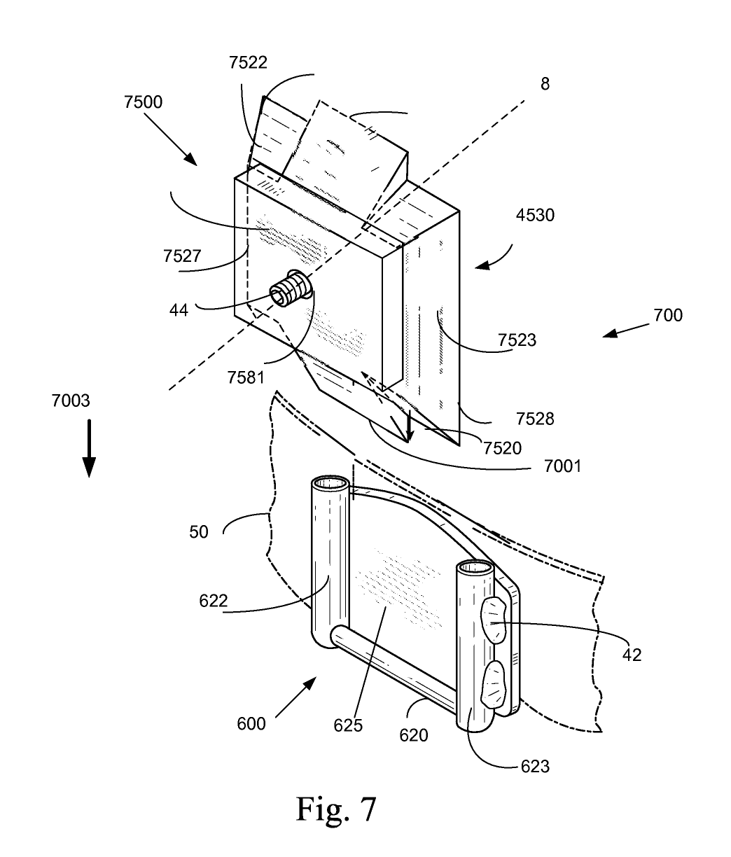

### FIGS. 7-9 Third Embodiment of First Coupling Part

FIG. 7 illustrates a coupling device 700 comprising a first part 7500 positioned for slideable engagement with an opposing second part 600. Second part 600 is similar to second part 600 illustrated previously with respect to the embodiments of FIGS. 3-6. First part 7500 differs slightly from second part 500 of previously described embodiments in that first part 7500 is formed to include a flange 7001 extending from a wedge portion 7520 of first part 7500. Flange 7001 engages slide stop flange 620 of second part 600 thereby limiting motion of first part 7500 with respect to second part 600 downwardly in the direction of arrow 7003.

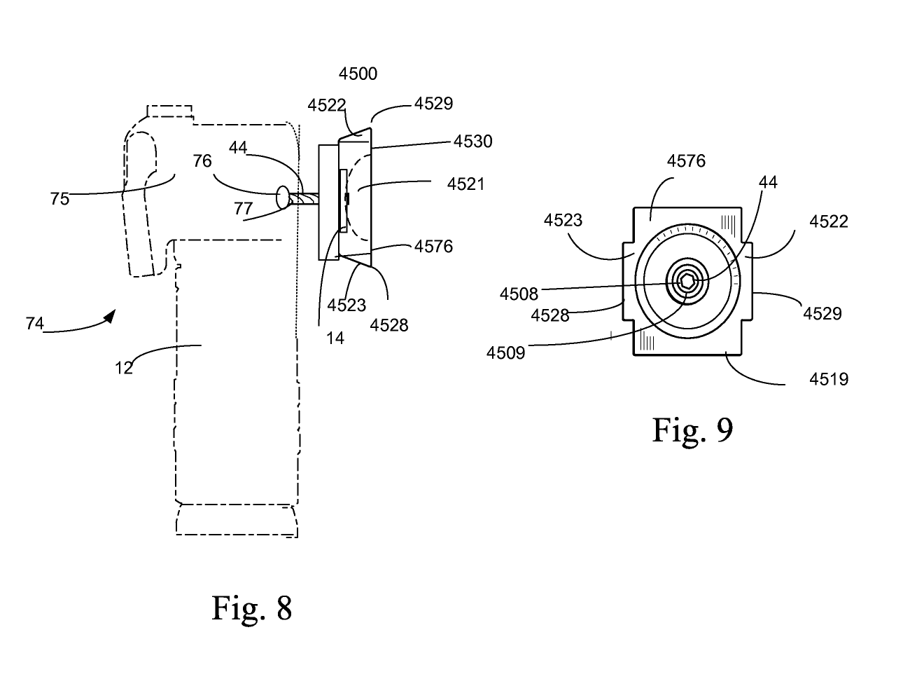

FIG. 8 is a top view of the embodiment of first part 7500 illustrated in FIG. 7 as it appears fixed to a camera and lens assembly 74. FIG. 8 further shows a side elevation view of a camera and lens assembly 74. Camera 75 includes a thread engaging receptacle 76. Many conventional cameras are equipped with a standard thread engaging receptacle 76 for use in affixing camera 75 to a tripod. The coupling device of the invention employs thread engaging receptacle 76 to secure camera 75 to a second part (illustrated for example in FIG. 3 at 500) by means of a threaded pin. (Illustrated, for example, in FIG. 3 at 44.)

FIG. 9 is a front elevation view of the embodiment of first part 7500 illustrated in FIG. 8.

### FIGS. 10-13: Fourth Embodiment of First Coupling Part

FIG. 10 is a perspective view of a coupling device 800 according to an alternative embodiment of the invention. Coupling device 800 comprises a first coupling part 8500 and an opposing second coupling part 600. Opposing second coupling part 600 for coupling device 800 is similar to the opposing parts 600 illustrated previously. First coupling part 8500 comprises a base portion 8580 including an opening 8581 in a central region of base portion 8580.

Base portion 8580 further includes rectangular extending portions 8591 and 8592. Extending portions 8591 and 8592 are generally rectangular in shape and defined by openings 8593 and 8594 respectively. Other shapes for extending portions are contemplated and the invention is not limited to embodiments wherein extending portions are rectangular. Extending portions 8591 and 8592 extend from base portion 8580 in a downwardly (in the direction of the arrow) and upwardly (in a direction opposite the direction of the arrow) respectively when first coupling part 8500 is oriented as illustrated in FIG. 10 and positioned for slideable engagement with second coupling portion 600.

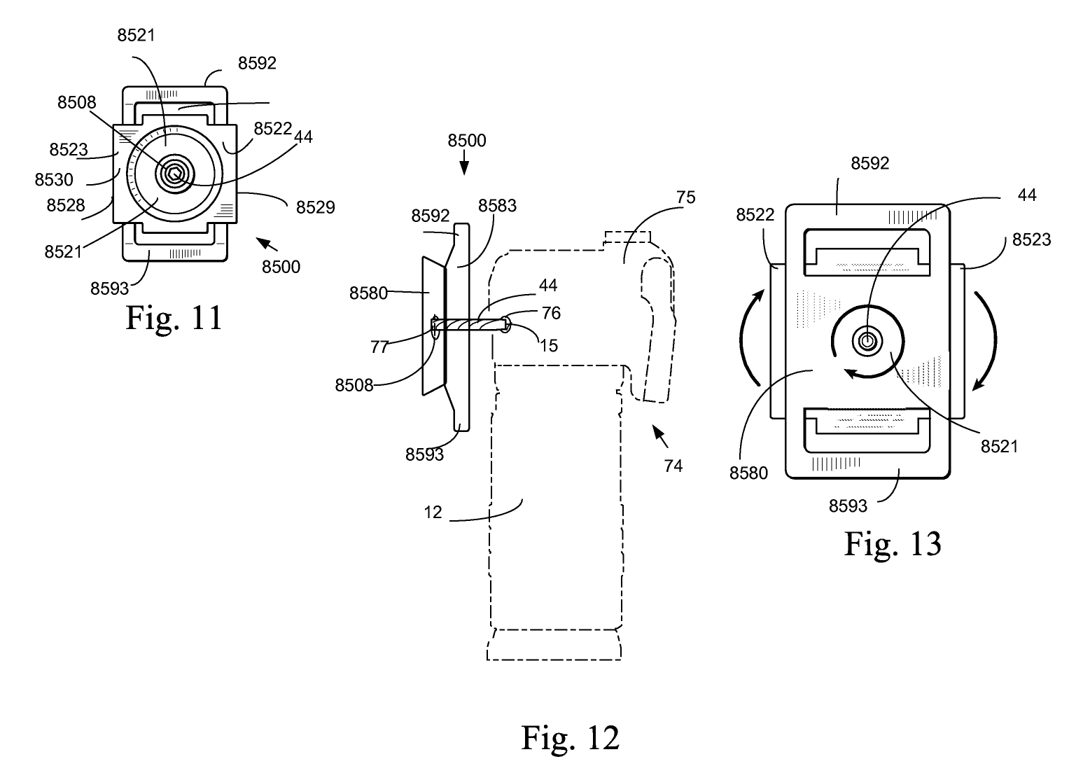

FIG. 11 is a front elevation view of the first coupling part 8500 illustrated in FIG. 10 with baseplate contacting surface 8530 of slider 8583 facing the viewer. FIG. 11 illustrates the relative positions of extensions 8592 and 8591 with respect to base portion 8580.

FIG. 12 is a top view of the first coupling part 8500 illustrated in FIG. 10. Pin 44 is illustrated as it appears when threadably engaged with receptacle 76 of camera 75. FIG. 13 is a front elevation view of first part 8500 as seen from the opposite side of that shown in FIG. 11. FIG. 13 illustrates rotation of first part 8500 about an axis of pin 44.

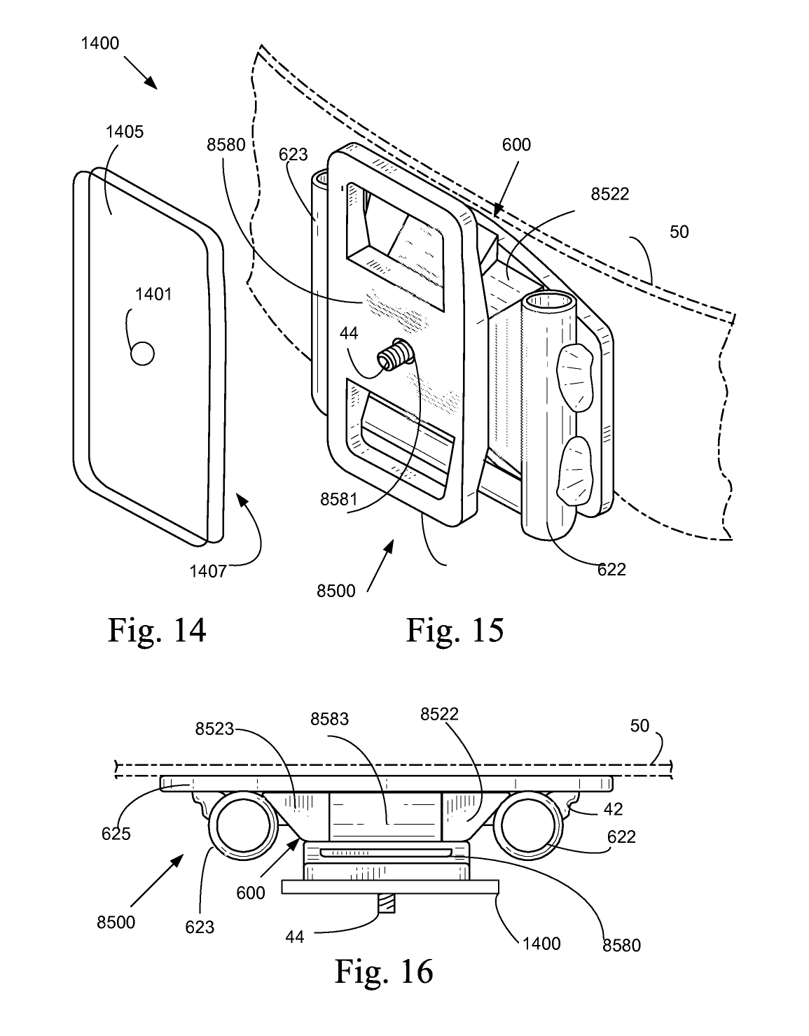

### FIGS. 14-16 Protective Barrier

FIG. 14 illustrates a camera protecting piece 1400 comprising a coupling device 1400 (illustrated in FIG. 15) according to an embodiment of the invention. FIG. 16 is a top view of coupling device 1400 of FIGS. 14 and 15 including protector 1401. Protector 1401 is interposed between based portion 8580 of first part 8500 and the housing of a camera 75 in the region of the camera's universal threaded receptacle (best illustrated in FIGS. 3 and 4). Protector 1401 acts as a protective buffer between metal portions of first part 8500 and the housing of a camera (for example camera 75 illustrated in FIGS. 1 and 2). Protector 1401 may be constructed from any type of soft, non abrasive material, for example, cloth such as felt, rubber foam materials and other non scratch or non-scuffing materials. Protector 1401 includes an opening 1401 for insertion of pin 44 prior to engaging threads of pin 44 with the threaded receptacle of a camera. Protector 1401 is generally rotatable about pin 44. Protector 1401 may or may not rotate in association with rotation of camera and lens assembly about an axis of pin 44. However, regardless of the amount of rotation of protector 1401, protector 1401 acts as a barrier preventing first part 8500 from directly contacting the housing of a camera to which first part 4500 is fixed.

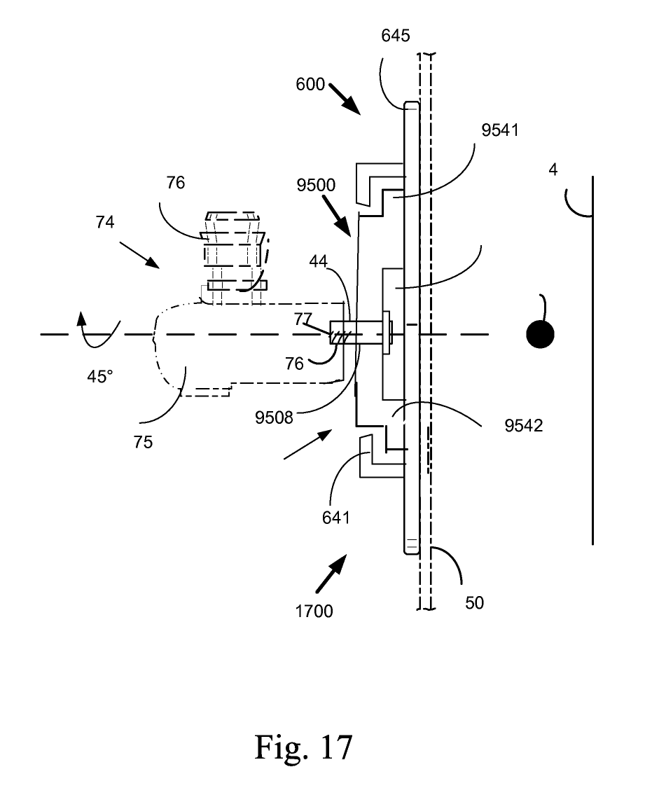

### FIG. 17 Alternative Embodiment of Coupling Device

FIG. 17 is a top view of a coupling device 1700 according to an alternative embodiment of the invention. Coupling device 1700 comprises a first coupling part 9500 and a second coupling part 9600. First coupling part 9500 is shown attached to a camera and lens assembly 74 by means of a pin 44. The distal end 77 of pin 44 is threaded for engaging a receptacle 76 of camera 75. The proximal end of pin 44 is disposed through an opening 9508 of first coupling part 9500 for pivotal engagement with an inside surface of opening 9508. In that manner camera and lens assembly 74 is pivotable about a central longitudinal axis of pin 44.

A second coupling part 9600 is fixed to a belt 50. Second part 9600 comprises a base plate 9625 having two guide members, 9622 and 9623 mounted thereupon. In one embodiment of the invention guide members 9622 and 9623 are fixed to base plate 9625 by welding the guide members to the base plate. A weld suitable for mounting guides 9622 and 9623 to base plate 9625 is illustrated in FIG. 10. Base plate 9600 further comprises a slide stop flange 9620 extending at least partially between lower portions of guide members 9622 and 9623. Slide stop flange 9620 limits downward travel of a slide, for example, first part 9500. Together, guide members 9622 and 9623 and slide stop flange 9620 provide a slot for receiving first part 9500.

An intermediate region 9519 is formed to define a cavity 9521 in coupling device 1700 when first part 9500 engages second part 9600. Flanges 9522 and 9523 are formed to permit slidable insertion of first part 9500 into slots 9642 and 9643. When inserted into slots 9642 and 9643, flanges 9522 and 9523 prevent first part 9500 from decoupling from second part 1600 by the stopping action of slot forming surface portions 9672 and 9673 of guides 9622 and 9623.

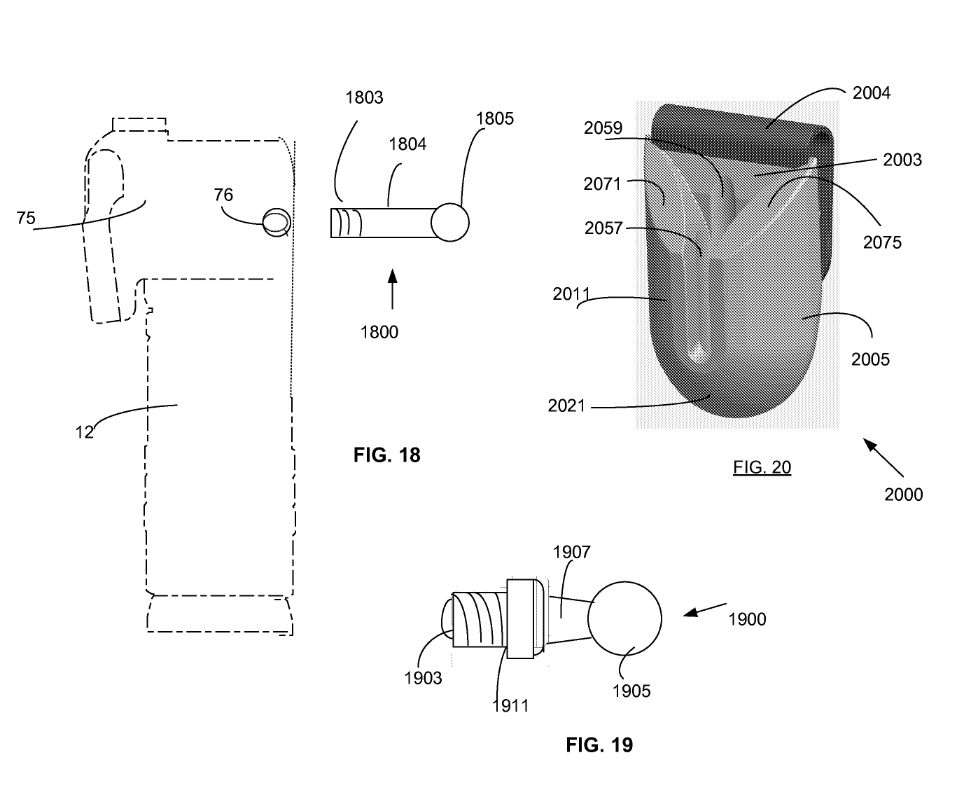

### FIG. 18

FIG. 18 illustrates a camera 75 including a thread receiving receptacle 76. A coupling device 1800 comprises a slot-engaging part 1805 for engaging a slot, for example slot 1870 illustrated in FIG. 19. A threaded pin 1804 is coupled to the slot engaging part 1805. Threads 1803 are disposed on one end portion of threaded pin 1804. Threads 1803 are configured to engage a thread receiving receptacle 76 of camera 75. In one embodiment of the invention the various components of coupling device 1800 may be constructed of steel, stainless steel, iron, or other rigid metal materials. However, alternative embodiments of the invention may employ other materials. Any rigid material capable of supporting the weight of camera 75 while coupling device is engaged in a support structure (e.g., device 2000) is suitable for comprising coupling device 1800.

The coupling device 1800 permits rotation of the camera 75 with respect to the support structure 2000 (illustrated in FIG. 20) when the thread receiving receptacle 76 of the camera 75 is engaged with threads 1803 of the threaded pin 1804 and the slot-engaging end portion 1805 is engaged with the slot 2057 (example illustrated in FIG. 20)

In one embodiment of the invention the slot engaging part 1805 of the coupling device comprises a knob. The knob may be formed as an integral part of the threaded pin. In other embodiments the knob may be formed separately and forged onto threaded pin 1804, for example by welding. In one embodiment of the invention, the knob and threaded pin comprise a coupling pin. In one embodiment of the invention, the threaded pin includes a head portion. In that embodiment the slot engaging part comprises a first body portion formed to slidably engage the slotted receptacle.

### FIG. 19

FIG. 19 illustrates an alternative embodiment 1900 of coupling device 1800. Coupling device 1900 further includes a neck portion 1907 formed between knob portion 1905 and threaded end portion 1903. A collar portion 1911 is disposed between threaded end portion 1911 and neck 1907.

### FIG. 20

FIG. 20 illustrates one example of a support structure at 2000. Support structure 2000 comprises a body portion 2021. Body portion 2021 includes front body portions 2005 and 2011 extending from a rear body portion 2003. Front body portions 2005 and 2011 define a slot 2057 for receiving knob 1805 of coupling device 1800. The support structure 2000 optionally comprises a belt clip 2004. The belt clip 2004 permits attachment of the support structure to a belt of a wearer. In one embodiment of the invention, the support structure 2000 generally provides a holster means for receiving coupling device 1800. The holster comprises a holster body 1863. The holster body has an opening 1870 in a front body portion. In some embodiments of the invention the holster includes a pressure exerting clip (not shown). The pressure exerting clip exerts pressure on a belt disposed between belt clip 2004 and holster rear body portion 2003 when the holster is attached to a belt.

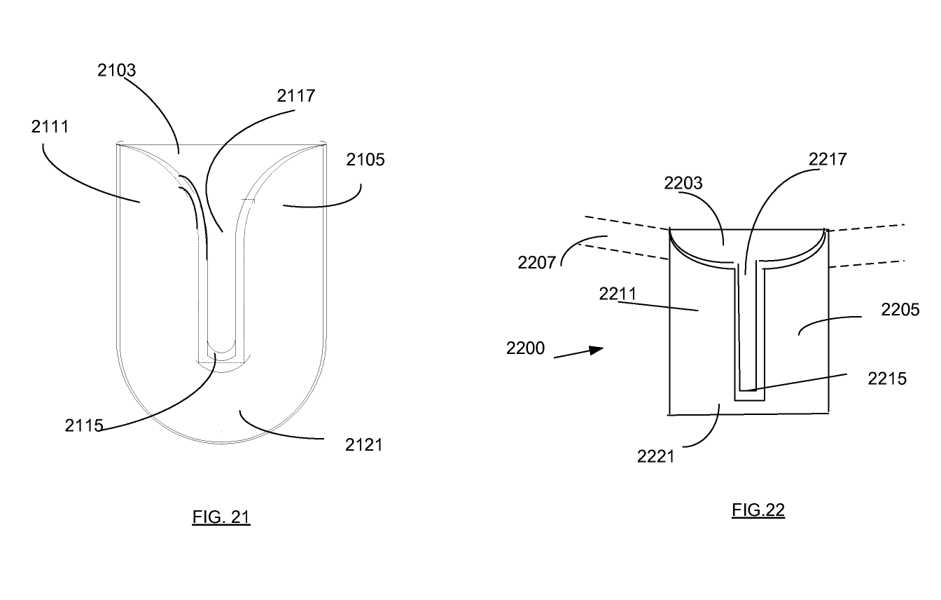

### FIGS. 21 and 22

FIG. 21 is a front view of a supporting structure according to an embodiment of the invention. A slot 2117 is defined by body portions 2111 and 2105 projecting from rear body portion 2303. A clip portion (not shown) may be formed on rear body portion 2103 for slidable attachment to a belt. A slot stop portion 2115 of slot 2117 is formed at an end portion 2121 of the supporting structure. Knob 1805 of coupling device 1800 engages slot 2117 and is slidable to the slide stop portion 2115. There coupling device 1800 rests allowing the supporting structure to support the weight of camera 75 through coupling device 1800.

FIG. 22 illustrates another embodiment of a supporting structure 2200. Supporting structure 2200 includes a front body portion comprising body portions 2211, 2205 and 2221. Body portions 2211, 2205 and 2221 extend outwardly from rear body portion 2203 to define a slot 2217. A slot stop portion 2215 is formed at the end of slot 2217 defined by body portion 2221. Rear body portion 2203 is affixed to a belt 2207, for example, by means of a clip affixed to rear body portion 2203. Alternative embodiments of the invention include other means for affixing rear body portion 2203 to a belt 2207 such as those described herein with respect to embodiments of the invention illustrated in FIG. 10.

In order to engage coupling device pin 1800 with holster 2200, knob 1805 is disposed within slot 2217. Slot 2217 is formed to allow knob 1805 to slide through slot 2217 toward end-stop portion 2315, with threaded pin 1804 extending outwardly through slot 2217. When thread receiving receptacle 76 of camera 75 is engaged with threads 1803 of threaded pin 1804, and knob 1805 is engaged in slot 2217, camera 76 is secured to supporting structure 2200. At the same time, slot 2217 is formed to allow knob 1805 to rotate within slot 2217 without disengaging threaded pin 1804 from supporting structure 2200.

Thus there have been provided new and improved methods and systems for carrying camera and lens assemblies on a belt of a wearer. While the invention has been shown and described with respect to particular embodiments, it is not thus limited. Numerous modifications, changes and enhancements will now be apparent to the reader.

What is claimed is:

1. A coupling device comprising:
a slot-engaging part for engaging a slotted receptacle of a support structure;
a threaded pin coupled to the slot engaging part, the threads configured to engage a thread receiving receptacle of a camera;
the coupling device configured to permit rotation of the camera with respect to the support structure when the thread receiving receptacle of the camera is engaged with threads of the threaded pin and the slot-engaging end portion is engaged with the slotted receptacle.

2. The coupling device of claim 1 further comprising the support structure, and wherein the support structure comprises a clip, and wherein the clip comprises:
a first side defining the slotted receptacle,
a second side permitting attachment of the clip to a belt of a wearer.

3. The coupling device of claim 1 wherein the support structure comprises a holster and the holster comprises:
a holster body having an opening in a front body portion defining the slotted receptacle; a holster rear body portion for supporting an attaching clip, the attaching clip for attaching the holster to a belt of a wearer.

4. The coupling device of claim 1 wherein the slot engaging part comprises a knob and the knob is formed as an integral part of the threaded pin.

5. The coupling device of claim 1 wherein the knob and threaded pin comprise a coupling pin.

6. The coupling device of claim 1 wherein the threaded pin includes a head portion and wherein the slot engaging part comprises:
a first body portion formed to slidably engage the slotted receptacle, the first body portion defining a central opening of sufficient diameter to pass there-through the threaded end portion of the threaded pin, the opening small enough to prevent passing there-through the head portion, such that the threaded pin is coupled to the first body portion when the first body portion is engaged with the slotted receptacle;
a second body portion having an opening there-through for passing the threaded end of the threaded pin such that the second body portion is coupled to the first body portion when the threaded end is engaged with the thread receiving receptacle of the camera.

7. A coupling piece comprising:
a slot engaging portion on one end for engaging a slotted receptacle of a camera supporting structure;
a camera engaging portion on another end for engaging a thread receiving receptacle of a camera;
the coupling piece configured to permit rotation of the camera with respect to the supporting structure when the camera is engaged with the coupling piece and the coupling piece is engaged with the slotted receptacle of the supporting structure.
